(19) United States
(12) Patent Application Publication
(10) Pub. No.: US 2010/0236113 A1
(43) Pub. Date: Sep. 23, 2010

(54) COVER RESEMBLING A BEVERAGE CONTAINER

(75) Inventor: Shelagh MCNALLY, Calgary (CA)

Correspondence Address: SHERIDAN ROSS PC, 1560 BROADWAY, SUITE 1200, DENVER, CO, 80202, US

(73) Assignee: BIG ROCK BREWERY OPERATIONS CORP., Calgary (CA)

(21) Appl. No.: 12/727,409

(22) Filed: Mar. 19, 2010

Related U.S. Application Data
(60) Provisional application No. 61/210,861, filed on Mar. 23, 2009.

(30) Foreign Application Priority Data
Mar. 20, 2009 (CA) 2,659,233

(51) Int. Cl. G09F 1/08

(52) U.S. Cl. 40/538

(57) ABSTRACT

A cover for hay bales and other three dimensional objects, and a method of advertising using the cover is described. The cover is generally of a size and shape to be wrapped about an cylindrical object having the relative proportions of a beverage can. When the cover is applied to hay bales, round bales may be stacked to provide suitable proportions. The cover bears indicia associated with a particular brand and/or type of beverage, such that the covered bales will resemble an enlarged version of the particular beverage can, thereby providing suitable advertising benefit to the beverage company.

### FIELD OF THE INVENTION

The present invention relates generally to covers for hay bales and other objects, and to the display of decorative and/or advertising indicia thereon. More particularly, a cover is described that may be secured about a cylindrical object having the general relative proportions of a beverage can, such that the cover will resemble a specific brand of beverage.

### BACKGROUND OF THE INVENTION

Round hay bales are often left exposed to the elements, and may be grouped together in a field for convenience. Bales are often left in fields for long periods of time. Such bales may not remain usable, and may also become an eyesore as weathering of the bales progresses.

Individual bales, or groups of bales, may be covered to minimize dry matter loss and spoilage due to plant respiration, microbial activity, and weather deterioration. When covering bales, it is generally accepted that bales should be placed side-lying on the ground in end-to-end rows, with each bale end firmly butted to the end of the next bale to minimize water penetration.

The side-lying rows of bales may also be stacked in pyramidal form, and covered with a single tarp. Alternatively, each row of bales may be bagged using specialized machinery for inserting the series of bales into a plastic sleeve, leaving a bagged row of bales. It is also recognized that drainage and air flow from the bales will minimize spoilage, so bale covers may include a vent to promote circulation and drainage of air and water, respectively.

### SUMMARY OF THE INVENTION

In a first aspect, there is provided a covering for application to a generally cylindrical object to provide a form resembling a beverage container, the covering comprising: a layer of material bearing design indicia, the design indicia similar to that typically displayed on containers of a particular brand of beverage; and a fastening system for fastening the covering against a generally cylindrical object.

In an embodiment, the relative proportions of the material, when fastened against the cylindrical object, are similar to the proportions of the typical container of the particular brand of beverage.

In an embodiment, the generally cylindrical object is a bale of hay or a stack of at least two round hay bales. When the object is a stack of bales, the material may extend across a surface of each bale, and the fastening system comprises an upper fastening portion for securing the material to the upper hay bale, and a lower fastening portion for securing the covering to the lower hay bale. The cover and fastening system may thereby be used to secure the bales into a single cylindrical form having relative proportions similar to the proportions of the typical container of the particular brand of beverage.

In an embodiment, the material is ultraviolet-resistant canvas.

The covering may comprise apertures along edges of the material, and the fastening system may comprise cords laced through the apertures and secured around the object. Further, cords may be laced through the apertures and secured at an end of the cylindrical object, to prevent slippage of the material along the length of the object.

In another embodiment, the fastening system comprises an elastic member operatively attached to the covering for holding the material against the generally cylindrical object. Further, the fastening system may be provided as a plastic sleeve for fitting over the object, with the covering secured to the sleeve so as to be displayed against the object when the plastic sleeve is fitted over the object. Still further, the fastening system may comprise a strap member for securing the material around the object.

The covering may be provided in sleeve-like configuration to fit around the entire cylindrical object, inherently providing a fastening system about the object.

In certain embodiments, the design indicia applied to the cover resembles that typically applied to a beer can, soda can, juice can, or canned product.

In accordance with a second aspect, there is provided a method for advertising a particular brand of beverage, the method comprising the steps of:
providing two or more hay bales at a location visible by potential customers;
arranging the bales into a three-dimensional form similar in relative proportions to that of a beverage container; and
applying indicia to the three dimensional form such that the three dimensional form resembles a beverage container associated with a particular brand of beverage.

In an embodiment, the location is adjacent a roadway.

In accordance with a third aspect, there is provided a method for advertising a particular product, the method comprising the steps of:
providing a three dimension form at a location visible by potential customers, the form having a shape and configuration similar in relative proportions to that of a particular product;
applying indicia to the three dimensional form such that the three dimensional form resembles an enlarged version of the particular product.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1a is a perspective view line drawing of a hay bale cover being affixed over two round hay bales;

FIG. 1b is a photograph of a hay bale cover being affixed over two round hay bales, the cover having a design so as to resemble a can of Grasshöpper™ beer;

FIG. 2a is a perspective view line drawing of a beverage can corresponding to the hay bale cover shown in FIG. 1a;

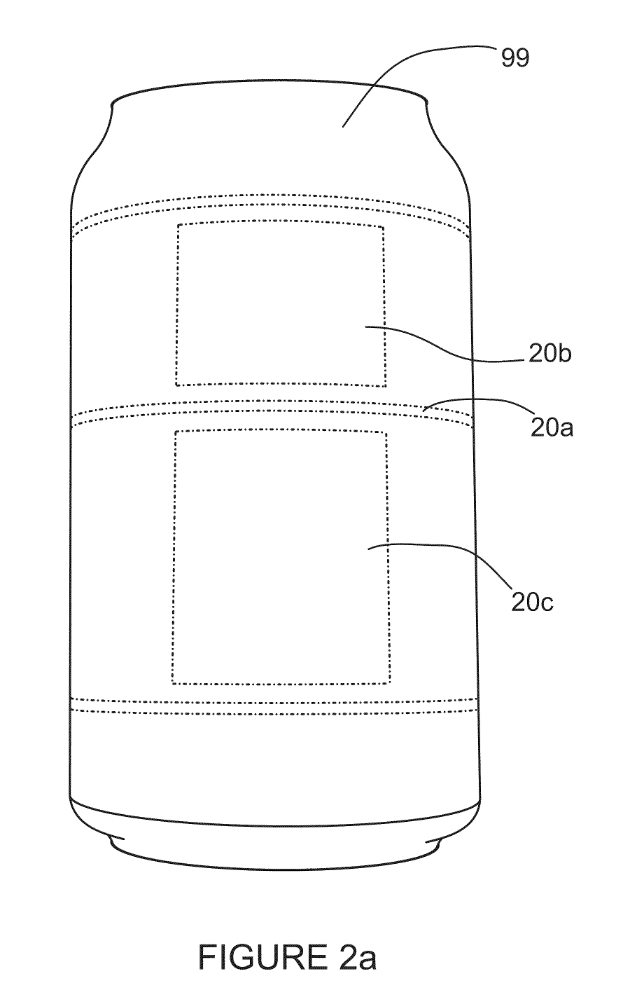

FIG. 2b is a photograph of a can of Grasshöpper™ beer corresponding to the hay bale cover shown in FIG. 1b;

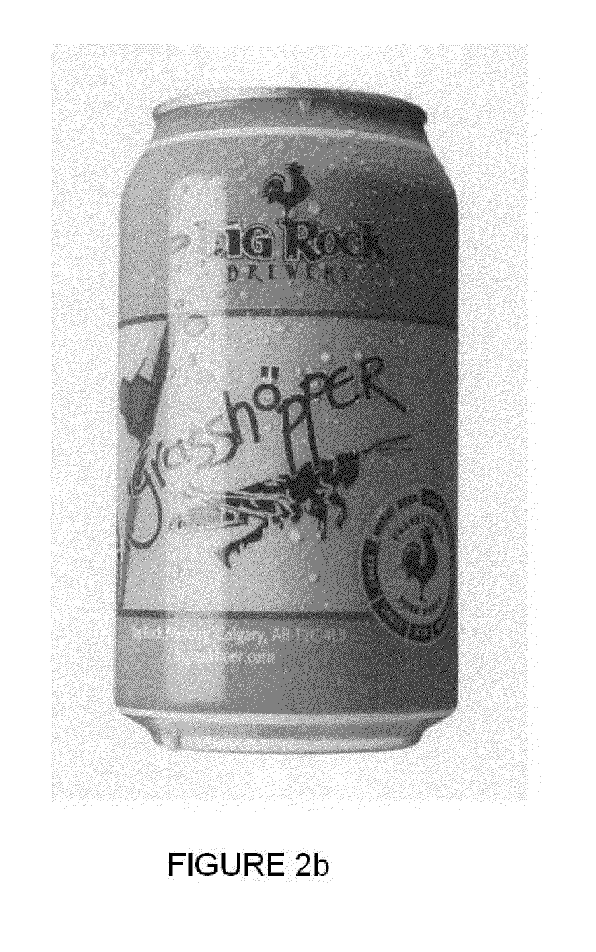

FIG. 3 is a photograph of two round hay bales being stacked to provide a cylindrical form resembling the proportions of a beverage can;

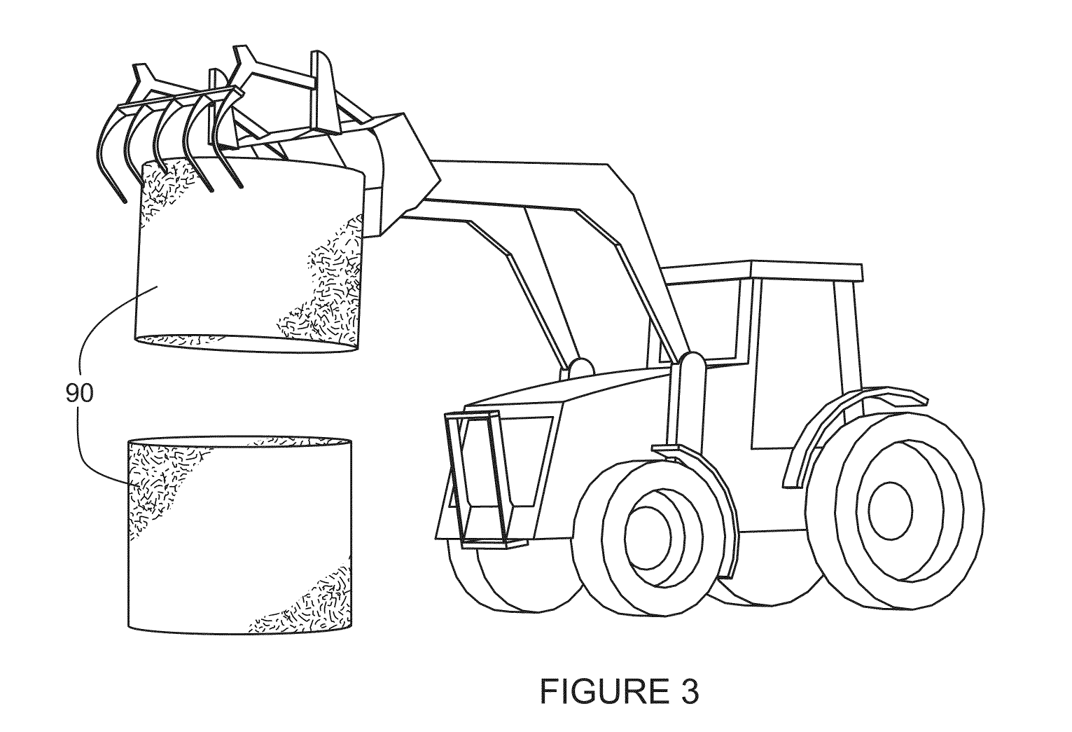

FIG. 4 is a photograph of a cover applied to two stacked round hay bales;

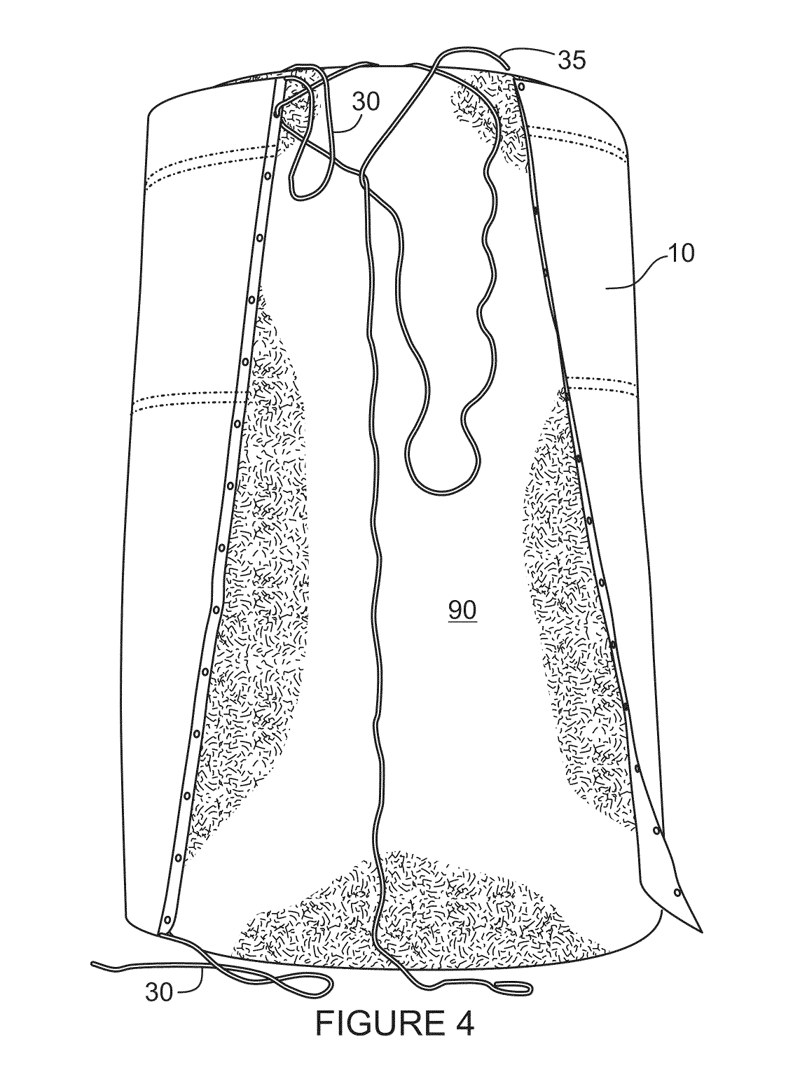

FIG. 5 is a photograph showing the fastening of the cover to the stacked hay bales; and

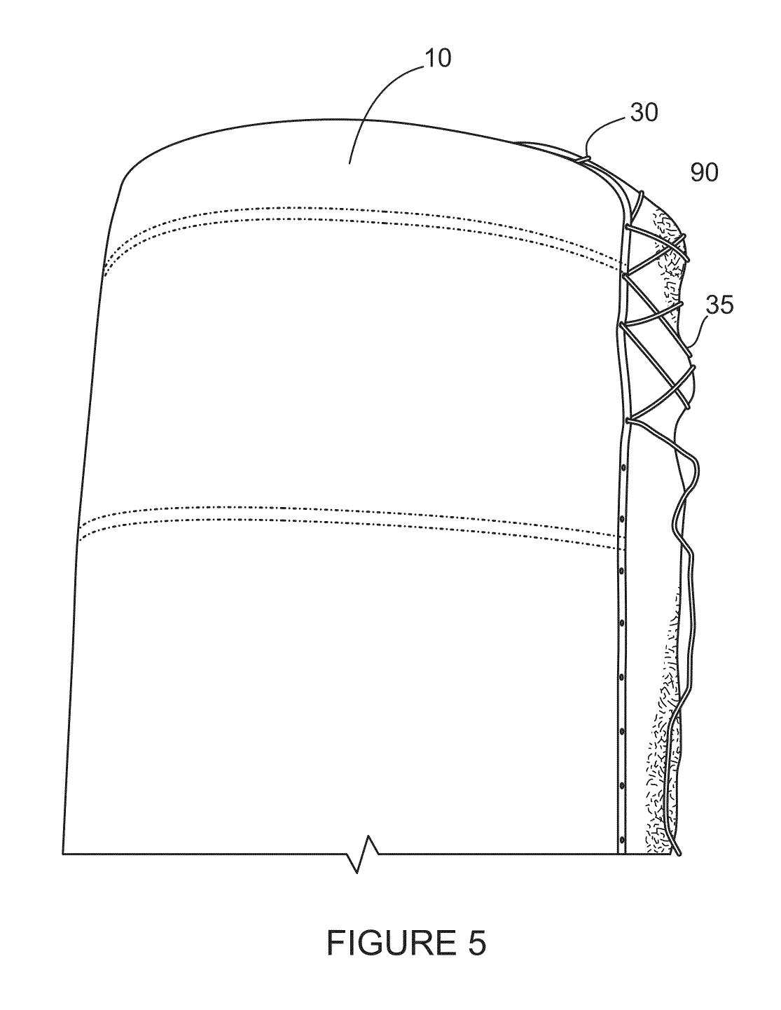

FIG. 6 is a schematic depicting the method for attaching a covering to a stack of round hay bales.

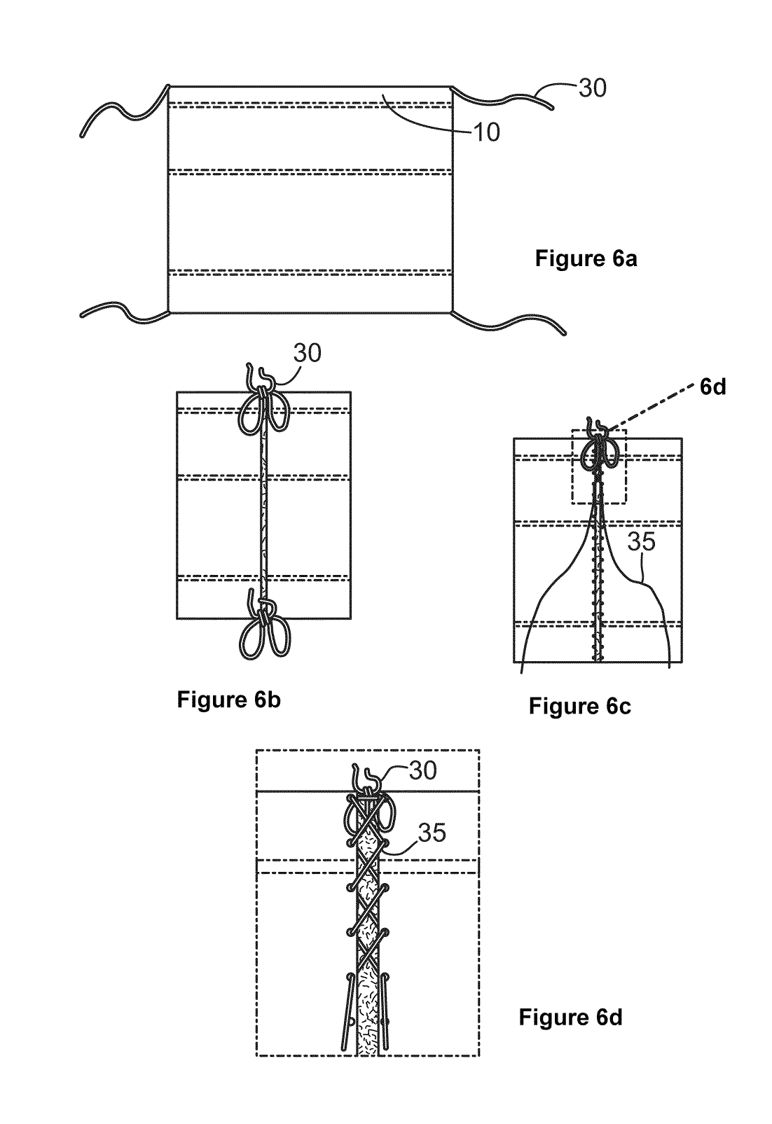

### DETAILED DESCRIPTION

Generally, a cover 10 for hay bales 90 and a method of advertising using the cover is described. The cover is generally of a size and shape to be applied to any suitable cylindrical object having the relative proportions of a beverage can 99. For example, a cover 10 may be applied to round hay bales 90 that have been stacked, end on end, to provide suitable proportions. The cover 10 bears indicia 20 (generally shown in the drawings by specific designs or broken lines) associated with a particular brand and/or type of beverage, such that the covered bales will resemble an enlarged version of the particular beverage can 99, thereby providing suitable advertising benefit to the beverage company.

Further, a method for using round hay bales 90 to assemble an advertisement is described.

### Cover

A suitable cover 10, for example of the type described herein and shown in the Figures, is formed from a flexible sheet of material, sized appropriately to extend around two stacked round hay bales 90. The cover 10 need not extend completely around the circumference of the stacked bales, 90 but should sufficiently cover the cylindrical object (in this case two stacked bales) such that a three-dimensional resemblance is recognizable from most available vantage points.

When covering hay bales, which may vary in size, the sheet of material may not fully extend around the bale, as shown. This allows the cover to be tightly fastened by first pulling the material taut, for example using cinch ties 30, and then fastening it tightly around the bales, for example by lacing a cord 35. Secure fastening will add stability to the stacked bales, preventing toppling.

When covering objects of predictable size and/or stable form, the sheet of material need not be pulled taut, and may extend across the top of the object or form, draping over the sides of the form. Further, the sheet of material may extend beneath the form. Various means of affixing the cover will be apparent to those reading the teaching provided herein.

The cover 10 may be formed of one or more types of material, selected based on various factors including the type and size of cylindrical form, or the appearance of the beverage container being simulated, etc. Elastic materials, waterproof materials, plastics, fabrics, and netting may each be suitable in particular applications. Further, the materials may be of a type that prevents fading, water damage, or other deterioration. For example, ultraviolet-resistant, water-resistant canvas has been used to date in covering bales, with favorable results.

### Indicia

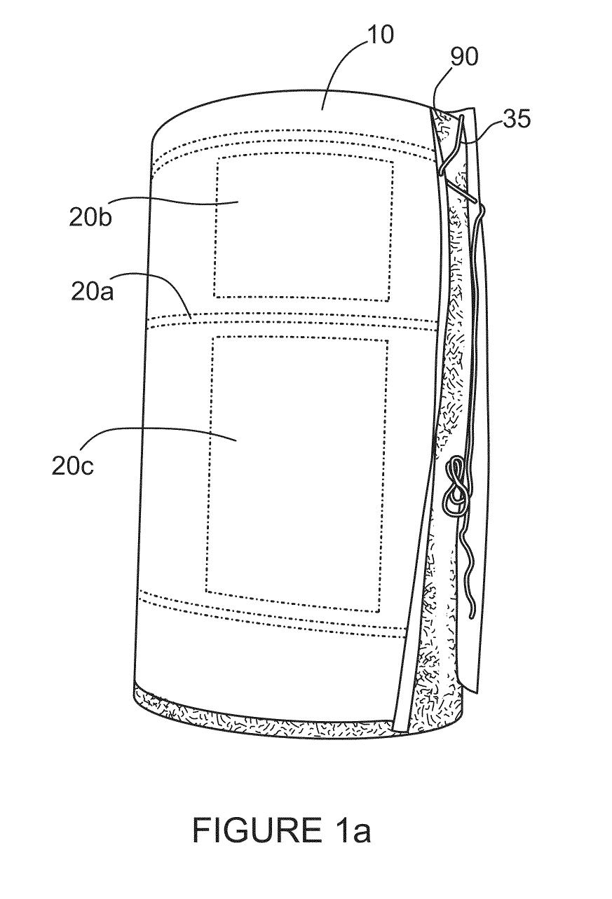

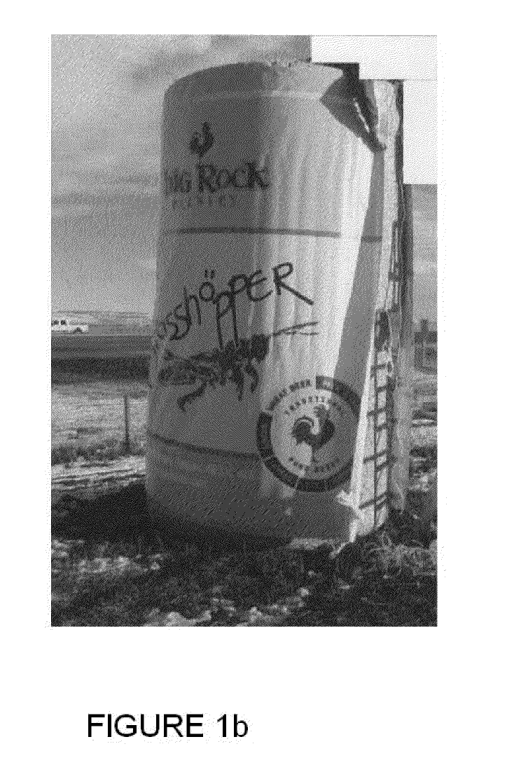

Indicia 20 are applied to the cover to simulate the appearance of a particular beverage container, thereby providing decorative, entertainment, and/or advertising benefit. The indicia may be applied in various locations and orientations, for example as shown in FIG. 1a (20a, 20b, 20c). For example, with reference to the Figures, a cover 10 is applied to two stacked round bales of hay 90 to simulate the general proportions and appearance of an aluminum beer can, namely a can of Grasshöpper™ beer 99, brewed by Big Rock Brewery™. Thus, the indicia 20 applied to the cover in this instance simulates the artwork typically applied to a can of Grasshöpper™ beer 99 such that individuals viewing the cover from a roadway, for example, would associate the covered bales with a can of Grasshöpper™ beer. Such user may thereby derive entertainment value from viewing the cover, and may also be more likely to purchase Grasshöpper™ beer some time in the future. Accordingly, beverage manufacturers may create a series of covers resembling their various beverage offerings. Similarly, this advertising system may also be used to display other cylindrical products, including canned foods, and household products.

The indicia 20 are generally intended to be visible from afar, and the covers and forms are therefore relatively large in size. Consideration should be taken in selecting the size of the cover (and of the three-dimensional object to be covered) such that when the indicia are applied to the cover, any distinguishing text or design on the cover would be visible and recognizable from appropriate vantage points.

### Cylindrical Form

The cylindrical form to be covered should have similar general proportions to the beverage container 90 being advertised. Various forms may be created or assembled to provide a form having suitable size and shape, based on the desired viewing location of the object and cover, and the indicia to be applied. A stack of two hay bales is suitable for viewing from a roadway, for example, and will provide the same general proportions as a typical aluminum beverage can.

A typical 355 mL aluminum can is generally twice as long as wide. That is, the ratio of height:diameter is about 2:1. Other can shapes are known. For example cans of tomato juice, iced coffee, fruit juices, or energy drinks may have a larger ratio, perhaps 3:1. Further, 500 mL cans, for example “tall boys”, may also be approximately 3:1, while “short” cans may be approximately 2:3. A wide range of can proportions are currently marketed, and the general proportions range from a ratio of approximately 1:1 to 4:1.

The cylindrical object should be sufficiently heavy to prevent tipping or shifting in position/orientation, particularly when the object is placed outdoors. Alternatively, the object or cover may be staked or tethered in place.

Various types of items could serve as a suitable three dimensional forms to which a cover may be applied to simulate a particular product. It may be suitable in some instances to cover unsightly objects with covers as described herein. For example, storage bins, silos, machinery, etc. may be contained beneath a cover, providing a new use for the otherwise unwanted object.

### Attachment to Form

The cover 10 may be placed over the cylindrical object, and may be actively or inherently fastened thereto. When the cover includes a top portion for extending over the form, no additional fastening may be required as the cover may simply drape over the object. The fit of the cover may be snug or loose.

In the cover shown in the Figures, the cover is first generally secured about the bales using cinch ties 30 at the top and bottom of the bales. The cover also has apertures along the side and top edges, through which a cord 35 may be laced and tied. The cord 35 is tied tightly around the stacked hay bales 90 to support the cylindrical form. Additional ties may be fastened over the top of the bales to prevent downward slippage of the cover.

Many mechanisms for fastening the cover to the form are possible, including straps, cords, ties, twine, adhesive, and the like. Further, the cover may be fastened to the object by additional material. For example, netting or elastic may be attached to the material bearing the indicia and stretched over the object. Further still, an elastic or plastic wrap may be applied over the material bearing the indicia to fasten the material to the object.

### Method

A method for advertising may be effected by applying a cover over an object, as described above. An object or group of objects having appropriate proportions to the product to be advertised is selected. A corresponding cover is designed that resembles the packaging or decorative design applied to the product, and an appropriate fastening means is attached or otherwise incorporated into the cover for affixing the cover to the object.

Many such covers and objects may be closely spaced or arranged into an appropriate configuration so as to be noticed by passersby. For example, when covers are applied to hay bales, a covered stack of bales or a grouping of covered bales may be placed at regular intervals in fields along a highway to provide periodic advertising of a particular product to drivers and passengers travelling along the highway. Such advertising may be placed at locations approaching a store or other establishment where the product is sold.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A covering for application to a generally cylindrical object to provide a form resembling a beverage container, the covering comprising: a layer of material bearing design indicia, the design indicia similar to that typically displayed on containers of a particular brand of beverage; and, a fastening system for fastening the covering against a generally cylindrical object.

2. The covering as in claim 1, wherein the relative proportions of the material, when fastened against the cylindrical object, are similar to the proportions of the typical container of the particular brand of beverage.

3. The covering as in claim 1, wherein the generally cylindrical object is one or more bales of hay.

4. The covering as in claim 1, wherein the generally cylindrical object is a stack of at least two round hay bales.

5. The covering as in claim 4, wherein the material extends across a surface of each bale.

6. The covering as in claim 5, wherein the fastening system comprises an upper fastening portion for securing the material to the upper hay bale, and a lower fastening portion for securing the covering to the lower hay bale, the cover and fastening system thereby securing the bales into a single cylindrical form having relative proportions similar to the proportions of the typical container of the particular brand of beverage.

7. The covering as in claim 1, wherein the material is ultraviolet-resistant canvas.

8. The covering as in claim 1, wherein the covering further comprises apertures along edges of the material, and wherein the fastening system comprises cords laced through the apertures and secured around the cylindrical object.

9. The covering as in claim 8, wherein the fastening system further comprises cords laced through the apertures and secured at an end of the cylindrical object, to prevent slippage of the material along the length of the object.

10. The covering as in claim 1, wherein the fastening system comprises an elastic member operatively attached to the covering for holding the material against the generally cylindrical object.

11. The covering as in claim 1, wherein the fastening system is a plastic sleeve for fitting over the object, and wherein the covering is secured to the sleeve so as to be displayed against the object when the plastic sleeve is fitted over the object.

12. The covering as in claim 1, wherein the fastening system comprises a strap member for securing the material around the object.

13. The covering as in claim 1, wherein the covering is sleeve-like in configuration, and fits around the entire cylindrical object, inherently providing a fastening system about the object.

14. The covering as in claim 1, wherein the design indicia resembles that typically applied to a beer can.

15. The covering as in claim 1, wherein the design indicia resembles that typically applied to a soda can.

16. The covering as in claim 1, wherein the design indicia resembles that typically applied to a juice can.

17. A method for advertising a particular brand of beverage, the method comprising the steps of:
providing two or more hay bales at a location visible by potential customers,
arranging the bales into a three-dimensional form similar in relative proportions to that of a beverage container;
applying indicia to the three dimensional form such that the three dimensional form resembles a beverage container associated with a particular brand of beverage.

18. The method as in claim 17, wherein the location is adjacent a roadway.

19. A method for advertising a particular product, the method comprising the steps of:
providing a three dimensional form at a location visible by potential customers, the form having a shape and configuration similar in relative proportions to that of the product;
applying indicia to the three dimensional form such that the three dimensional form resembles an enlarged version of the product.
